(19) United States
(12) Patent Application Publication
(10) Pub. No.: US 2020/0290279 A1
(43) Pub. Date: Sep. 17, 2020

(54) THREE-DIMENSIONAL PRINTER, FEED SYSTEM AND METHOD

(71) Applicant: KEYLAND POLYMER MATERIAL SCIENCES, LLC, Cleveland, OH (US)

(72) Inventor: Martin Angelo SANZARI, Wayne, NJ (US)

(21) Appl. No.: 16/649,203

(22) PCT Filed: Sep. 20, 2018
(86) PCT No.: PCT/US2018/051976

§ 371 Date: Mar. 20, 2020

Related U.S. Application Data
(60) Provisional application No. 62/561,066, filed on Sep. 20, 2017.

(51) Int. Cl. B29C 64/329; B33Y 10/00; B33Y 30/00; B33Y 50/02; B33Y 40/00; B29C 64/295; B29C 64/264; B29C 64/393; B29C 64/106

(52) U.S. Cl. CPC B29C 64/329; B33Y 10/00; B33Y 30/00; B33Y 50/02; B29C 64/106; B29C 64/295; B29C 64/264; B29C 64/393; B33Y 40/00

(57) ABSTRACT

One or more of feed systems for printers, printers and methods for building a three-dimensional product are provided. A feed chamber of the feed system stores a particulate material, and a deposition chamber receives the particulate material stored by the feed chamber. A heater is in thermal communication with a heating region of the deposition chamber to convert the particulate material into a gel. A nozzle provided to the deposition chamber emits the gel in a pattern to build the three-dimensional product. A conveyance system transports the particulate material towards the heating region and expels the gel from the deposition chamber through the nozzle according to instructions of a control system. An ultraviolet light source such as one or more ultraviolet LEDs can be arranged adjacent to the nozzle to cure the deposited gel using ultraviolet light.

### BACKGROUND

Additive production techniques involve depositing successive layers of a material in a pattern to form a product. The material being deposited is typically converted into a flowing form from a solid material. However, conventional additive production systems have traditionally employed separate, complex systems to individually transport the solid material and meter the material being deposited.

### SUMMARY

In accordance with the present disclosure, a feed system for a printer that builds a three-dimensional product is provided. The feed system includes a feed chamber that stores a particulate material, and a deposition chamber that receives the particulate material stored by the feed chamber. A heater is in thermal communication with the deposition chamber to elevate a temperature of the particulate material within a heating region of the deposition chamber, thereby converting the particulate material into a gel. A nozzle is provided to the deposition chamber to emit the gel in a pattern to build the three-dimensional product. A conveyance system transports the particulate material towards the heating region and expels the gel from the deposition chamber through the nozzle. A control system in communication with the conveyance system controls operation of the conveyance system.

According to some examples, a printer that builds a three-dimensional product includes a platen that supports the three-dimensional product while the three-dimensional product is being built. A control system controls movement of the platen and a plurality of feed systems during building of the three-dimensional product. Each, or at least one of the feed systems includes a feed chamber that stores a particulate material, and a deposition chamber that receives the particulate material stored by the feed chamber. A heater is in thermal communication with the deposition chamber to elevate a temperature of the particulate material within a heating region of the deposition chamber to convert the particulate material into a gel. A nozzle provided to the deposition chamber emits the gel in a pattern to build the three-dimensional product. A conveyance system transports the particulate material towards the heating region and expels the gel from the deposition chamber through the nozzle.

Some examples involve a method of operating a feed system of a printer that builds a three-dimensional product. The method involves using a control system comprising a processor that executes computer-executable instructions stored by a non-transitory computer-readable memory. Operation of a heater in thermal communication with a heating region of the deposition chamber is initiated to convert a particulate material in the heating region into a gel. A control signal is issued to selectively operate a conveyance system to urge the particulate material into a deposition chamber, and expel the gel from a nozzle provided to the deposition chamber. A platen supporting the three-dimensional product being built is moved to cause the gel to be deposited in a pattern corresponding to the three-dimensional product. An ultraviolet light source is energized to irradiate the gel being expelled from the nozzle with ultraviolet light.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a block diagram schematically illustrating a three-dimensional printer including an illustrative example of a feed system.

FIG. 2 is a block diagram schematically illustrating a three-dimensional printer including a plurality of feed systems.

FIG. 3 is a block diagram schematically illustrating a portion of one feed system shown in FIG. 2, including a conveyance system that utilizes a gas to transport particulate material and expel a gel from a deposition chamber, where a supply door is in an open state and a charge door is in a closed state.

FIG. 4 is a block diagram schematically illustrating the portion of the feed system shown in FIG. 3, with the supply door in a closed state and the charge door in an open state.

FIG. 5 is a flow diagram schematically illustrating a method of operating a feed system of a printer with a control system to build a three-dimensional product.

FIG. 6 shows an illustrative embodiment of an ultraviolet light emitting diode (UV LED) that can be used to cure deposited gel material using ultraviolet light.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any illustrative embodiments set forth herein as examples. Rather, the embodiments are provided herein merely to be illustrative. Such embodiments may, for example, take the form of hardware, software, firmware or any combination thereof.

One or more feed systems for a printer that builds a three-dimensional product, one or more printers with at least one such feed system, and a method of operating one or more such feed systems are provided. For example, each, or at least one feed system includes a conveyance system. The conveyance system is operable to transport a particulate material toward a heating region of a deposition chamber to be converted into a gel, and expel the gel from the deposition chamber through a nozzle. The conveyance system can be also controlled independently of at least one other feed system provided to the same printer. Some embodiments of the conveyance system utilize a gas from a common gas source to transport the particulate material toward the heating region and to expel the gel from the deposition chamber for each of a plurality of independently-operated feed systems.

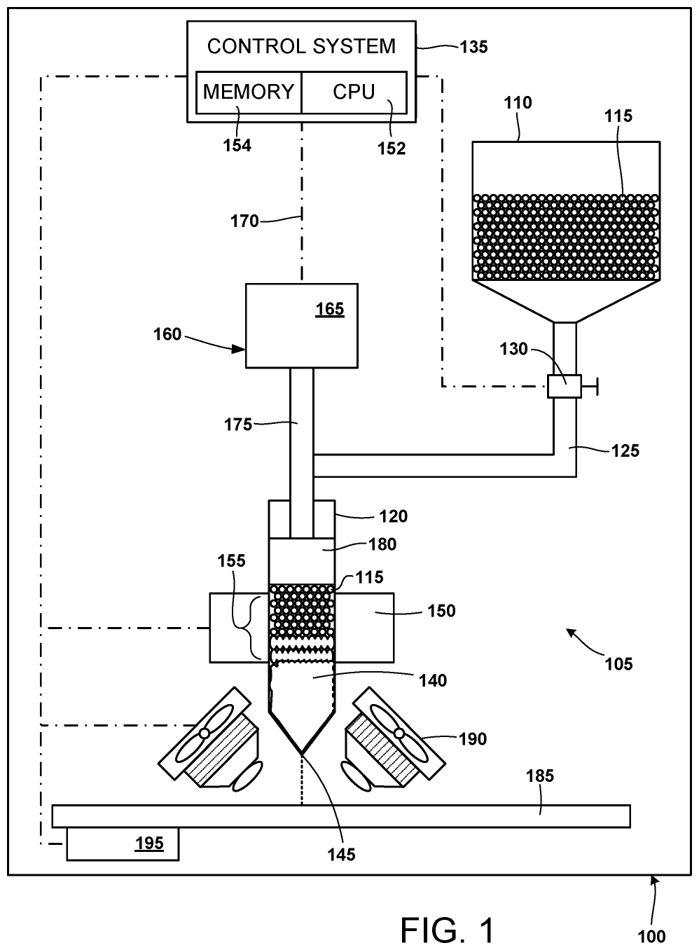

With reference to the drawings, FIG. 1 schematically shows an example of a three-dimensional printer 100 including an example of a feed system 105. As shown, the feed system 105 includes a feed chamber 110 that stores a particulate material 115, such as particles of a thermosetting resin, a thermoplastic resin, or other material. The feed chamber 110 can define an enclosed compartment in which a quantity of the particulate material 115 can be staged for delivery to a deposition chamber 120. A conduit 125 extending between the feed chamber 110 and the deposition chamber 120 establishes a feed path along which the particulate material 115 is supplied to the deposition chamber 120. A valve 130 can be electronically actuated, pneumatically-actuated, or actuated by other means according to a control routine executed by a control system 135 to supply the required particulate material 115 to the deposition chamber. Examples of the valve 130 include, but are not limited to a gate valve, a ball valve, etc.

The deposition chamber 120 can include a substantially-cylindrical vessel formed from stainless steel or other rigid material. The material from which the deposition chamber 120 is formed can withstand high temperatures in excess of one hundred (100° C.) degrees Celsius, or other temperatures required to melt the particulate material 115 into a gel 140, for example, without the deposition chamber 120 being plastically deformed. A nozzle 145 defines an orifice through which the gel 140 is expelled from the deposition chamber as a stream with a cross-sectional shape suitable to build the three-dimensional product as part of the additive production process.

An electric heater 150 is provided adjacent to, and optionally at least partially (or fully) surrounds an exterior of the deposition chamber 120 to create a heating region 155. The heater 150 is in sufficient thermal communication with the heating region of the deposition chamber 120 to melt the particulate material 115 within the heating region 155. Melting the particulate material 115 creates a viscous volume, referred to herein as the gel 140, of the material introduced to the deposition chamber 120 in particulate form. The gel 140 can be expelled in a continuous stream under pressure exerted on the particulate material 115 within the deposition chamber 120 by a conveyance system 160, as described below.

The illustrative example of the conveyance system 160 shown in FIG. 1 includes a stepper motor 165 or other driver operatively connected to the control system 135 by a hardwired or wireless communication channel 170. The control system 135 can optionally include a processor 152 that executes computer-executable instructions stored in a non-transitory memory 154, for example. Although a control system is represented by a single block in FIG. 1, utilizing a processor 152 and a memory 154, the control system 135 can be a distributed system, including a plurality of control modules, controlling different components of the printer 100. Under the control of the control system 135, the stepper motor 165 is operated to drive a linkage comprising one or a plurality of rotatable lead screws 175 in response to a demand for the gel 140 to be deposited as part of the additive production process. Rotation of the lead screws 175 causes insertion of a plunger 180 into the deposition chamber 120 in the direction of nozzle 145. The resulting pressure exerted on the particulate matter 115 and gel 140 within the deposition chamber 120 expels the gel 140 through the nozzle 145 onto a platen 185 supporting the product being built during the additive production process.

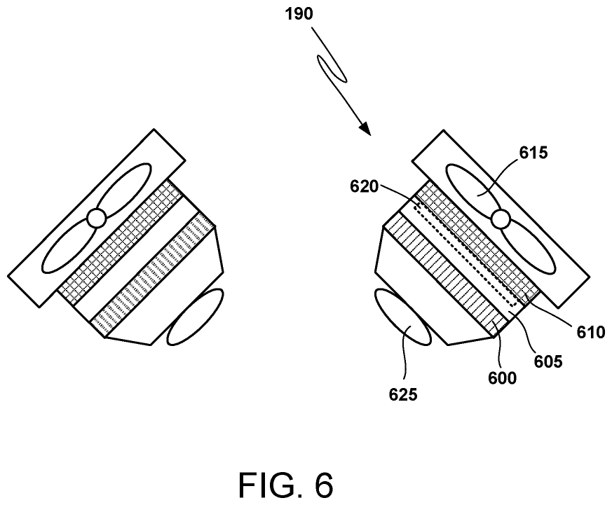

Gel 140 expelled from the deposition chamber 120 is deposited onto the platen 185, or onto previously-deposited gel 140 forming an underlying layer of the product being built. Deposited gel can be allowed to cool and solidify to form a layer of the product, or the deposited gel can be cured to form a layer of the product. Curing the gel can involve molecular crosslinking an ultraviolet light curable resin through exposure to ultraviolet light emitted by an array of ultraviolet light emitting diodes (“LEDs” or “UV LEDs”) 190, or exposure to heat or another crosslinking agent. The UV LEDs 190, described below with reference to FIG. 6, can be arranged at a stationary location adjacent to the nozzle 145 or on an articulating (e.g., robotic) arm to immediately irradiate the gel 140 as the gel 140 is deposited in a gelled state, in which the gel 140 is mobile, or flowable in a manner similar to a viscous fluid. The position of the platen 185 is adjusted by an actuator 195 according to instructions from the control system 135 as the gel 140 is deposited to establish the shape of the product being produced.

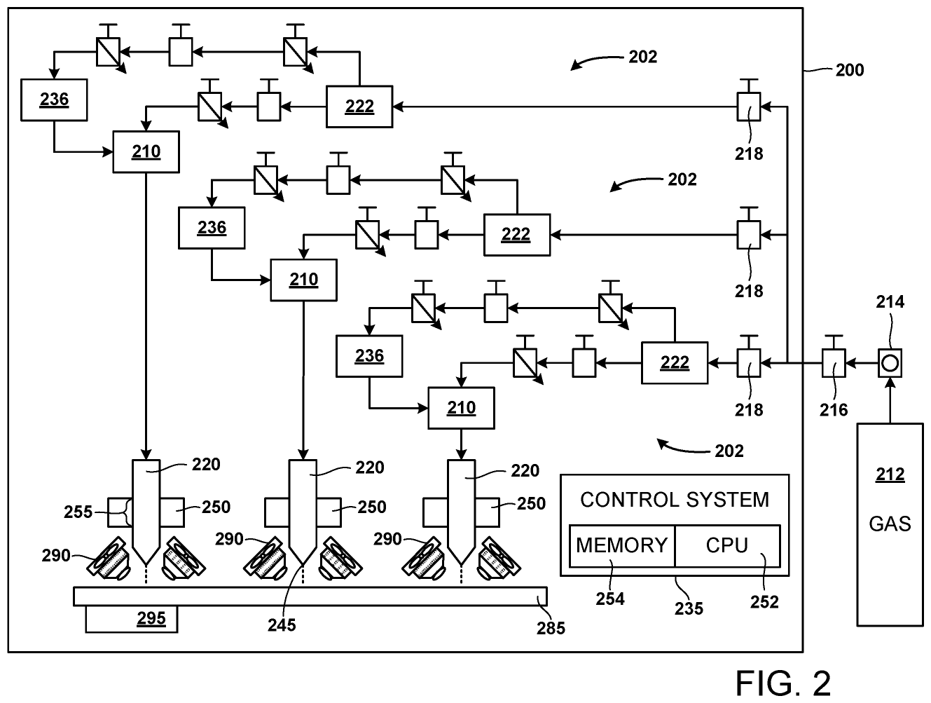

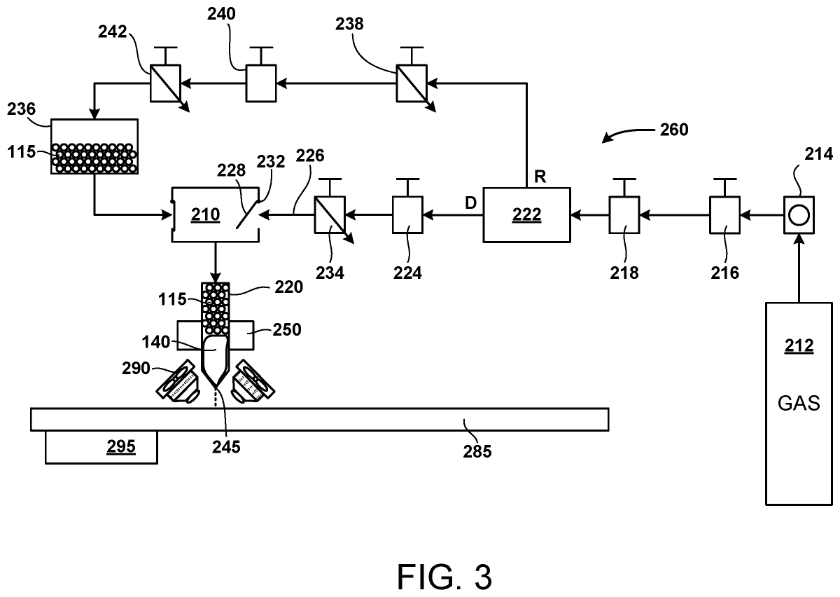

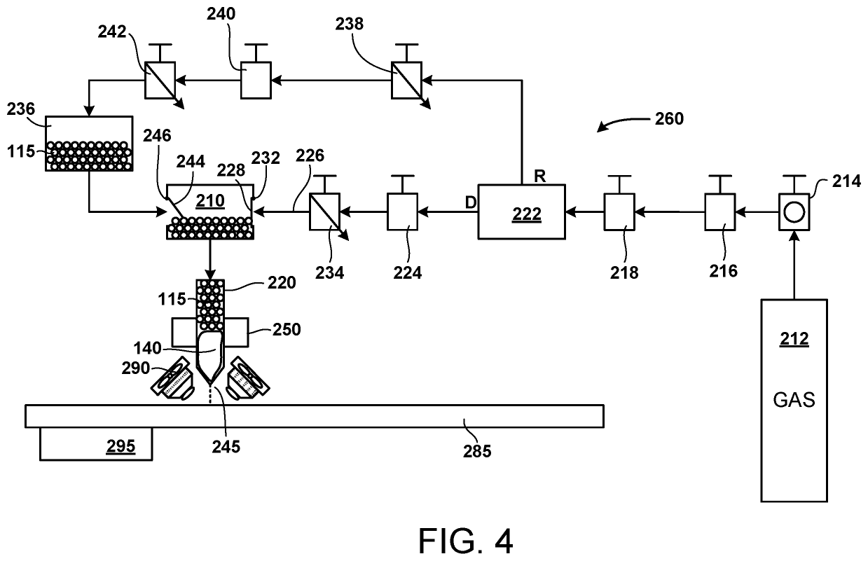

Some embodiments of a conveyance system 260 (FIGS. 3 and 4) can utilize fluid pressure or fluid flow to transport the particulate material from the feed chamber to the deposition chamber. For example, FIG. 2 illustrates an embodiment of a printer 200 that includes a plurality of feed systems 202. Each, or a plurality or at least one of the feed systems 202 includes such a conveyance system 260. One or more, and optionally each of the feed systems 202 includes a feed chamber 210 that stores the particulate material 115 to be supplied to a deposition chamber 220. The stored particulate material 115 can be conveyed through a conduit extending between the feed chamber 210 and the deposition chamber 220. The particulate material 115 delivered to the deposition chamber 220 is melted within the heating zone 255 to form the gel 140. The delivery of the particulate material 115 to the deposition chamber 220 expels the gel 140 from the deposition chamber 220 through the nozzle 245 onto the platen 285, which is moved by the actuator 295. The deposited gel 140 can then be cured in response to being exposed to ultraviolet light emitted by an array of UV LEDs 290. Such features are similar to the respective features described with reference to FIG. 1, so further discussion of those features is omitted here.

The feed systems 202 in FIG. 2 can be independently controlled by the control system 235 to deposit one, or a plurality of different materials, as required to produce the desired product. Controlling the supply of the particulate material 115 for the feed systems 202 can be achieved by a conveyance system 260 that controls the flow of a gas from a gas source 212 using a network of valves. For the sake of clearly illustrating embodiments of the feed system 202, a portion of one feed system 202 provided to the printer 200 in FIG. 2 is shown in FIGS. 3 and 4, isolated from the other feed systems 202 provided to the printer 200. However, the structure and operation of the portion of the feed system 202 described below with reference to FIGS. 3 and 4 can be the same for each of the feed systems 202 shown in FIG. 2. According to embodiments utilizing a mobile nozzle 145, the UV LEDs 190 can be coupled in a fixed relationship relative to the nozzle 145 to move along with movement of the nozzle 145.

An illustrative embodiment of the UV LEDs 190 that can be used to cure deposited gel material using ultraviolet light is shown in FIG. 6. An ultraviolet light source such as a high-power UV LED bulb 600 can be mounted to a circuit board 605 supporting circuitry for controlling operation of the UV LED bulb 600. High-power UV LED bulbs 600 can draw currents of at least one (1 A) amp, at least two (2 A) amps, at least three (3 A) amps, etc. To protect such a high-power UV LED bulb 600 from degradation as a result of overheating, the circuit board 605 can include a metal or metal-alloy layer 620 (shown using hidden lines) forming a portion of the circuit board's core or substrate. The metal or metal-alloy material (e.g., aluminum, copper, combinations and alloys thereof, etc.) can be placed in thermal communication with a heat sink 610. Thermal paste or other heat-conducting joining material can be disposed between the circuit board 605 and the heat sink 610 to facilitate the transfer of thermal energy away from the UV LED bulb 600. A fan 615 or other cooling device such as a liquid reservoir, phase change refrigeration device, etc. can be coupled to remove thermal energy from the heat sink at a rate that exceeds the rate of cooling afforded by natural convection. Operation of the UV LEDs 190 can be controlled by the control system as described herein.

Ultraviolet light emitted by the UV LED bulb(s) 600 may be omnidirectional according to some embodiments. A lens 625 can be arranged adjacent to the UV LED bulb(s) 600 to focus the omnidirectional ultraviolet light in a direction toward a target location. The target location can be a point where the gel 140 is expelled from the nozzle 145 onto an underlying surface, such as previously-extruded gel 140 forming a portion of the three-dimensional product or the platen 285 for example. Embodiments of the lens 625 can be formed from any ultraviolet-transparent material such as quartz, for example.

With reference to FIGS. 2 and 3, the gas source 212 can be a cylinder or other suitable reservoir storing a gas at an elevated pressure, relative to atmospheric pressure, such as compressed air, an inert gas such as nitrogen, or other transport gas. The gas can optionally be chosen such that the gas does not undergo a chemical reaction with the particulate material 115. The gas source 212 can optionally be integrally installed as part of the printer 200, or can be an external source, that does not form part of the printer 200 but is coupled to an inlet port of the printer 200.

The gas from the gas source 212 flows through a regulator 214 to establish an inlet pressure suitable for the conveyance system 260. The gas is turned on or off to the system by a valve 216, which can be electronically controlled by the control system 235, but can be a pneumatically-actuated valve or actuated by any other suitable mechanism according to some embodiments. When the system is operational this valve 216 can remain in the open state, allowing the gas from the regulator 214 to reach a valve 218 that is operable to isolate the gas flow of one conveyance system 260 from at least one, and optionally each of the other conveyance systems 260 provided to the printer 200. For the feed system 202 to become operational, the valve 218 is opened to allow the gas from the gas source 212 to enter an inlet port provided to a gas tank 222 specific to the feed system 202, thereby filling the gas tank 222. The gas supplied from the gas tank 222 is used to transport the particulate material 115 through the feed system 202.

The valve 218 can open and close in a minimal amount of time designated tᵥₐₗᵥₑ. Opening and closing the valve 218 at the minimum time tᵥₐₗᵥₑ will cause an increase in pressure on the system side of the valve 218 (i.e., the side downstream of the valve 218 where the gas tank 222 is located), as shown in FIG. 3. The pressure on the supply side of the valve 218 (i.e., the side upstream of the valve 218 where the gas source 212 is located) is controlled by the pressure regulator 214. The change in pressure within the feed system 202 with the valve 218 opening and closing in time tᵥₐₗᵥₑ is represented by expression [1], which is defined as follows:

$$Δ P = \frac{RT \dot{m} {t}_{valve}}{V} \qquad [ 1 ]$$

where R is the ideal gas constant (8.314 J/mol. K), T is the temperature of the gas, \dot{m} is the mass flow rate of the gas and V is the volume of the portion of the feed system 202 on the system side of the valve 218. The volume of the gas tank 222 can be chosen to establish a desired resolution of the pressure change on the system side of the valve 218 in the feed system 202.

For Mach numbers satisfying the inequality

$$\dot{m} = A \sqrt{\frac{( {p}_{1}^{2} - {p}_{2}^{2} )}{RT ( f \frac{L}{D} + 2 ln \frac{{p}_{1}}{{p}_{2}} )}} \qquad [ 2 ]$$

the mass flow is given by expression [2], which is defined as follows:

$$Ma < \frac{1}{\sqrt{k}} ,$$

In expression [2], A is the cross sectional area of the tubing/pipe carrying the gas, f is the friction factor of the tubing/pipe, L is the length of the tubing/pipe, D is the diameter of the tubing/pipe, k is the ratio of the specific heats. Equation [1] shows that the pressure change is inversely proportional the volume of the feed system 202, which can be established by selecting a suitably-sized gas tank 222 for each feed system 202. The change in pressure in the deposition chamber 220 is a function of the pressure change in equation [1], which translates into the change in force applied to the particulate material 115 in the deposition chamber 220 and, accordingly, the force imparted on the gel 140 in the deposition chamber 220. Thus, the amount of gel 140 expelled from the nozzle 245 of the deposition chamber 220 is proportional to the pressure change on the gel 140.

The volume of the gas tank 222 is a factor that at least partially, and optionally primarily defines the quantity of the gel 140 that can expelled from the deposition chamber 220 with a single opening of the valve 218, while a valve 224 between the gas tank 222 and the feed chamber 210 remains open. The gel 140 can optionally be expelled from the deposition chamber 220 at a substantially constant rate by maintaining the valves 218, 224 in an open state (e.g., a state that allows the gas to flow through the valves 218, 224). In other words, the deposition path (denoted by the letter “D” at the outlet of the gas tank 222) stemming from the gas tank 222 is opened to convey the gas for depositing the gel 140 without introducing new particulate material 115 to the feed chamber 210. The gas flowing through the valves 218, 224 and the conduit 226 result in the opening of a supply door 228 leading into the feed chamber 210 as shown in FIG. 3. The supply door 228 is normally biased closed by a torsion spring 232 or other suitable biasing device. With the supply door 228 pushed open by the pressure of the gas, the pressure within the feed chamber 210 grows as a result of the influx of the gas. The elevated pressure within the feed chamber 210 urges the particulate material 115 from the feed chamber 210 into the deposition chamber 220. Further, the elevated pressure within the feed chamber also causes the gel 140 to be expelled from the deposition chamber 220 onto the movable platen 285.

A relief valve 234 between the valve 224 and the feed chamber 210 allows for the pressure within the conduit 226 be at least partially relieved by venting at least a portion of the gas in the conduit 226 to the ambient environment. Venting the portion of the gas from the conduit 226 lowers the pressure in the conduit 226 to a level that can be overcome by the force of the torsion spring 232, causing the supply door 228 to return to a closed state. Venting the portion of the gas via the relief valve 234 also terminates deposition of the gel 140 from the deposition chamber 220.

The conveyance system 260 also includes a replenishment path (denoted by the letter “R” at the outlet of the gas tank 222) stemming from the gas tank 222. The replenishment path ultimately leads to the feed chamber 210, but includes a hopper 236 that stores a quantity of the particulate matter 115 to be delivered to the feed chamber 210 for replenishing the particulate material supply within the feed chamber 210. Along the replenishment path, a relief valve 238 is arranged between a valve 240 and the gas tank 222. The relief valve 238, when opened by the control system 235, vents the gas from the gas tank 222 and the portion of the replenishment path between the valve and the gas tank 222 to the ambient environment of the conveyance system 260. Similarly, a relief valve 242 can be provided along the replenishment path between the hopper 236 and the valve 240.

As shown in FIG. 4, the valve 240 can be electronically-actuated, pneumatically actuated, or actuated in any other manner to open the conduit of the replenishment path between the hopper 236 and the gas tank 222. Adjusting the valve 240 to open the conduit of the replenishment path results in the gas flowing from the gas tank 222 to the hopper 236. The gas flow through the hopper 236 entrains the particulate material 115 in the flowing gas, or otherwise urges the particulate material 115 in the hopper 236 into the feed chamber 210. As shown in FIG. 4, the pressure resulting from the gas passing through the hopper opens a charge door 244 along the replenishment path that is normally biased closed by a torsion spring 246 or other biasing mechanism. Particulate material 115 entrained within the gas or expelled from the hopper 236 by the pressure increase caused by the influx of gas into the hopper 236 enters the feed chamber 210 through the open charge door 244. The elevated pressure within the feed chamber 210 from the influx of gas passing through the hopper 236 also urges the supply door 228 closed, preventing the backflow of particulate material 115 up the deposition path. This elevated pressure is also imparted on the particulate material 115 and gel 140 within the deposition chamber 220, causing the gel 140 to be expelled from the nozzle 245. When the quantity of the particulate material 115 within the feed chamber 210 has reached a threshold level, the valve 240 can be closed, and the pressure within the hopper at least partially relieved through operation of the relief valve 242. Operation of the relief valve 242 can also optionally relieve sufficient pressure along the replenishment path to allow the force of the torsion spring 246 to close the charge door 244.

Continued deposition of the gel 140 without transporting the particulate material 115 from the hopper 236 to the feed chamber 210 can be achieved by opening the deposition path through operation of the valve 224. The supply door 228 will be opened, and the charge door 244 will be maintained in a closed state. Regardless of whether the particulate material 115 is being transported to the feed chamber 210, as the gel 140 is being deposited, it is illuminated by high intensity ultraviolet light emitted by the UV LEDs 290, curing the gel as it is being deposited.

The control system described herein, and as shown in the drawings, can optionally include a processor, such as processor 252 in FIG. 2 for example, that executes computer-executable instructions stored by a non-transitory computer-readable memory, such as memory 254 in FIG. 2 for example, to perform the control operations described herein. The processor 252 and memory 254 can optionally be packaged as a monolithic semiconducting circuit component, with the executable instructions stored as firmware. Although the control system is shown in the drawings as a single block, it is to be understood that the control system 135, 235, can be a distributed system, including a plurality of distributed components, and is not limited to a single controller. Regardless of the structure of the control system, the executable instructions can transmit signals along wired or wireless communication channels (such as the channels 170 shown in FIG. 1, for example) to control: actuation of any of the valves described herein, operation of a heater in thermal communication with a heating region of the deposition chamber, operation of the UV LEDs, movement of the platen, or operation of the stepper motor.

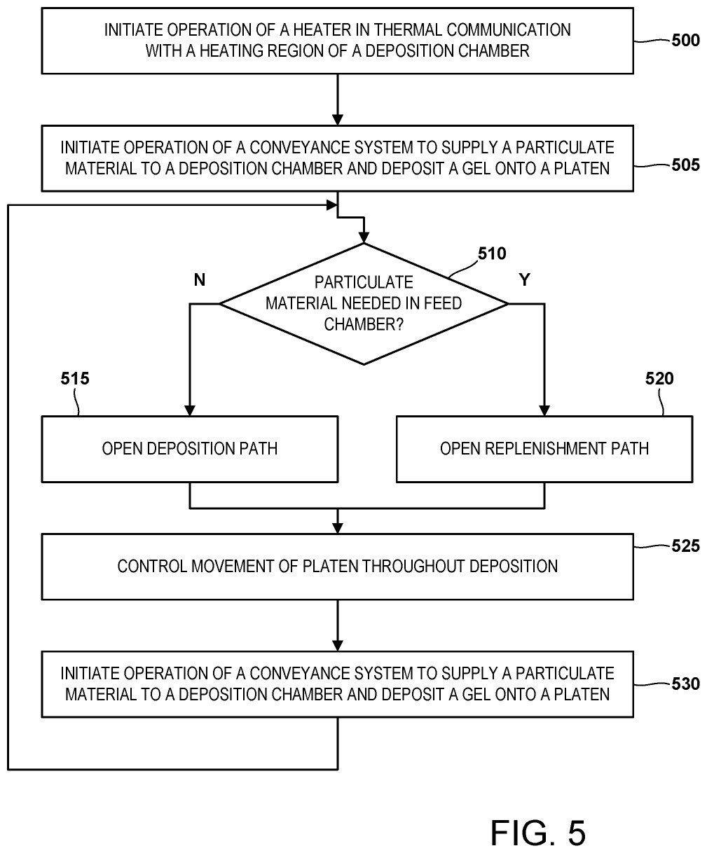

A flow diagram schematically illustrating a method of operating the feed system 202 of the printer 200 with the control system 235 to build a three-dimensional product is shown in FIG. 5. Operation of the heater 250 in thermal communication with the heating region 255 of the deposition chamber 220 is initiated at 500. The thermal energy emitted by the heater 250 converts a particulate material 115 into a gel 140 to be deposited onto the platen 285 during the additive production process. Operation of the conveyance system 260 is initiated at 505 to transport the particulate material 115 to the feed chamber 210 and then into the deposition chamber 220, where the particulate material 115 is converted into the gel 140. The mode of operation of the conveyance system 260 depends on whether there is at least a threshold quantity of the particulate material 115 in the feed chamber 210.

If, at 510, it is determined that at least the threshold quantity of the particulate material 115 is present in the feed chamber 210, the valve 224 is operated to open the deposition path at 515. The replenishment path remains closed. With the deposition path open, gas flows into the feed chamber 210 through the open supply door 228 and elevates the pressure therein. The elevated pressure urges the particulate material 115 from the feed chamber 210 into the deposition chamber 220 and into the heating region 255, where the particulate material 115 is melted to form the gel 240. The elevated pressure also causes the gel 140 to be expelled from the deposition chamber 220 via the nozzle 245.

If, at 510, it is determined that the threshold quantity of the particulate material 115 is not present in the feed chamber 210, the valve 240 is operated to open the replenishment path at 520. The deposition path remains closed. With the replenishment path open, gas flows into the hopper 236, conveying the particulate material 115 from the hopper 236 into the feed chamber 210 through the open charge door 244, and elevates the pressure within the feed chamber 210. The elevated pressure urges the particulate material 115 from the feed chamber 210 into the deposition chamber 220 and into the heating region 255, where the particulate material 115 is melted to form the gel 240. The elevated pressure also causes the gel 140 to be expelled from the deposition chamber 220 via the nozzle 245.

Throughout deposition of the gel 140, movement of the platen 285 relative to the nozzle 245 of the deposition chamber 220 is controlled at 525 to create the pattern of the deposited gel 140 corresponding to the product. Ultraviolet light is emitted at 530 to cure the gel 140 as it is deposited, resulting in the accumulation of the gel 140 during the additive production process. The process returns to 510 to monitor the quantity of the particulate material 115 in the feed chamber 210 during the additive production process at 510.

As used in this application, “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a control system and the control system can be a component. One or more components may reside within a process and/or thread of execution and a component may be localized on one computer and/or distributed between two or more computers (e.g., nodes(s)).

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example,” “illustrative embodiment,” are used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer (e.g., node) to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments and/or examples are provided herein. The order in which some or all of the operations are described herein should not be construed as to imply that these operations are necessarily order dependent. Alternative ordering will be appreciated by one skilled in the art having the benefit of this description. Further, it will be understood that not all operations are necessarily present in each embodiment and/or example provided herein. Also, it will be understood that not all operations are necessary in some embodiments and/or examples.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. A feed system for a printer that builds a three-dimensional product, the feed system comprising:
a feed chamber that stores a particulate material;
a deposition chamber that receives the particulate material stored by the feed chamber;
a heater in thermal communication with the deposition chamber to elevate a temperature of the particulate material within a heating region of the deposition chamber to convert the particulate material into a gel;
a nozzle provided to the deposition chamber to emit the gel in a pattern to build the three-dimensional product;
an ultraviolet light source arranged adjacent to the nozzle for irradiating the gel emitted by the nozzle with ultraviolet light to cure the gel emitted by the nozzle;
a conveyance system that transports the particulate material towards the heating region and expels the gel from the deposition chamber through the nozzle; and
a control system in communication with the conveyance system to control operation of the conveyance system.

2. The feed system of claim 1, wherein the conveyance system comprises:
a gas tank in fluid communication with the feed chamber, wherein the gas tank stores a gas at an elevated pressure that is greater than atmospheric pressure; and
a valve that is operable to selectively open a flow path between the gas tank and the feed chamber, wherein
the control system is in communication with the valve to control a flow of the gas into the feed chamber to build a biasing pressure within the feed chamber that urges the particulate material into the heating region and expels the gel from the deposition chamber.

3. The feed system of claim 2 comprising a relief valve disposed along the flow path between the gas tank and the feed chamber to at least partially relieve a line pressure within the flow path.

4. The feed system of claim 2 comprising a hopper coupled to the feed chamber, wherein the hopper stores the particulate material and supplies the particulate material to the feed chamber.

5. The feed system of claim 4, wherein the hopper is in fluid communication with the gas tank and the gas from the gas tank urges the particulate material in the hopper toward the feed chamber.

6. The feed system of claim 5 comprising a hopper valve that is controlled by the control system to selectively open an airway between the gas tank and the hopper.

7.-8. (canceled)

9. The feed system of claim 1, wherein the conveyance system comprises:
a lead screw that extends into a proximate end of the deposition chamber; and
a drive motor operable to rotate the lead screw to transport the particulate material to the heating region and expel the gel from the deposition chamber, wherein
the control system is in communication with the drive motor to control rotation of the lead screw to transport the particulate material through the deposition chamber and expel the gel from the deposition chamber.

10. (canceled)

11. The feed system of claim 1 comprising a lens arranged to focus the ultraviolet light emitted by the ultraviolet light source on a target location where the gel emitted by the nozzle is deposited.

12. (canceled)

13. A printer that builds a three-dimensional product, the printer comprising:
a platen that supports the three-dimensional product while the three-dimensional product is being built;
a control system that controls movement of the platen during building of the three-dimensional product; and
a plurality of feed systems, wherein at least one of the feed systems comprises:
a feed chamber that stores a particulate material,
a deposition chamber that receives the particulate material stored by the feed chamber,
a heater in thermal communication with the deposition chamber to elevate a temperature of the particulate material within a heating region of the deposition chamber to convert the particulate material into a gel,
a nozzle provided to the deposition chamber to emit the gel in a pattern to build the three-dimensional product,
an ultraviolet light source arranged adjacent to the nozzle for irradiating the gel emitted by the nozzle with ultraviolet light to cure the gel emitted in the pattern, and
a conveyance system that transports the particulate material towards the heating region and expels the gel from the deposition chamber through the nozzle.

14. The printer of claim 13, wherein the conveyance system comprises:
a gas tank in fluid communication with the feed chamber, wherein the gas tank stores a gas at an elevated pressure that is greater than atmospheric pressure; and
a valve operatively connected to the control system to selectively open a flow path between the gas tank and the feed chamber to build a biasing pressure within the feed chamber that urges the particulate material into the deposition chamber and expels the gel from the deposition chamber through the nozzle.

15.-16. (canceled)

17. The printer of claim 14, wherein the at least one of the feed systems comprises a hopper coupled to the feed chamber, wherein the hopper stores the particulate material and supplies the particulate material to the feed chamber.

18. The printer of claim 17, wherein the hopper is in fluid communication with the gas tank and the gas from the gas tank urges the particulate material in the hopper toward the feed chamber.

19. The printer of claim 14, wherein the conveyance system comprises a hopper valve that is controlled by the control system to selectively open an airway between the gas tank and the hopper.

20.-23. (canceled)

24. The printer of claim 13, wherein the conveyance system comprises:
a lead screw that extends into a proximate end of the deposition chamber; and
a drive motor operable to rotate the lead screw to transport the particulate material to the heating region and expel the gel from the deposition chamber, wherein
the control system is operatively connected to the drive motor to control rotation of the lead screw to transport the particulate material through the deposition chamber and expel the gel from the deposition chamber.

25. A method of operating a feed system of a printer that builds a three-dimensional product, the method comprising, with a control system comprising a processor that executes computer-executable instructions stored by a non-transitory computer-readable memory:
initiating operation of a heater in thermal communication with a heating region of a deposition chamber to convert a particulate material in the heating region into a gel;
issuing a control signal that selectively operates a conveyance system to: (i) urge the particulate material into the deposition chamber, and (ii) expel the gel from a nozzle provided to the deposition chamber;
moving a platen supporting the three-dimensional product being built to deposit the gel in a pattern corresponding to the three-dimensional product; and
initiating operation of an ultraviolet light source to irradiate the gel being expelled from the nozzle with ultraviolet light.

26. The method of claim 27, wherein issuing the control signal that selectively operates the conveyance system causes delivery of a gas at an elevated pressure from a gas tank to a feed chamber storing the particulate material, urging the particulate material into the deposition chamber, and expelling the gel from the nozzle.

27. The method of claim 28 comprising issuing, with the control system, a supply signal that results in delivery of the gas to a hopper to transport the particulate material from the hopper to the feed chamber.

28. The method of claim 27 comprising issuing, with the control system, a relief signal that opens a relief valve to at least partially relieve a pressure within at least one of the feed chamber, the deposition chamber or the hopper.

29. The method of claim 28 comprising issuing, with the control system, an inlet signal that opens a gas flow path between a gas source and an inlet of the gas tank to establish the elevated pressure within the gas tank.

30. The method of claim 27, wherein issuing the control signal that selectively operates the conveyance system causes operation of a driver motor to rotate a lead screw that threadedly transports the particulate material into the deposition chamber and expels the gel from the nozzle.
